(19) United States
(12) Patent Application Publication
(10) Pub. No.: US 2024/0126929 A1
(43) Pub. Date: Apr. 18, 2024

(54) INTEGRATED CIRCUIT AND OPERATION METHOD

(71) Applicant: Sharp Semiconductor Innovation Corporation, Tenri City (JP)

(72) Inventor: Yukihiro SHIMAMOTO, Tenri City (JP)

(21) Appl. No.: 18/377,049

(22) Filed: Oct. 5, 2023

(30) Foreign Application Priority Data
Oct. 11, 2022 (JP) 2022-163368

(51) Int. Cl. G06F 21/72; H04L 9/06

(52) U.S. Cl. CPC G06F 21/72; H04L 9/06

(57) ABSTRACT

An integrated circuit that implements a MUL64 function of a SNOW-3G cipher circuit includes: a calculation circuit configured to calculate, for combinations of integers x and y satisfying n=x+y, 128 1-bit operation results N(n) that are all exclusive ORs of a logical AND of V[x] that is a value of 64-bit V of an x-th bit, and P[y] that is a value of 64-bit P of a y-th bit, where n is an integer ranging from 0 to 127, the value of 64-bit V being a first argument of the MUL64 function, the value of 64-bit P being a second argument of the MUL64 function; and an output circuit configured to output a MUL64 function value [63:0] by performing either a logical-AND operation or an exclusive-OR operation, or both using data indicating 128 pieces of M(n), and using 128 pieces of the N(n), wherein the M(n) is a value calculated by applying 1 to a first argument of a MUL64×POW function included in the MUL64 function, applying the n to a second argument of the MUL64×POW function, and applying a predetermined value to a third argument of the MUL64×POW function.

### CROSS-REFERENCE TO RELATED APPLICATION

The present application claims priority from Japanese Application JP2022-163368, the content of which is hereby incorporated by reference into this application.

### BACKGROUND OF THE INVENTION

### 1. Field of the Invention

The present disclosure relates to an integrated circuit and an operation method that implement a MUL64 function of a SNOW-3G cipher circuit.

### 2. Description of the Related Art

SNOW-3G is known as a data encryption scheme in communication. A MUL64 function for integrity verification has been standardized in SNOW-3G.

A MUL64×POW function is recursively defined in the MUL64 function. A recursively defined function can be implemented by a combinational circuit of nesting structure. However, if the number of times for executing such a circuit of nesting structure is unknown, or if this circuit of nesting structure is executed many times, a nesting structure cannot be made, and hence, a recursively defined function is typically implemented by a sequential circuit.

On the other hand, it unfortunately takes a long time for a sequential circuit to output an operation result. In addition, the sequential circuit has another problem: a value is easily read through power-supply current analysis, such as simple power analysis (SPA) or differential power analysis (DPA) Accordingly, a technique of implementing a MUL64 function with a combinational circuit has been required.

Chinese Unexamined Patent Application Publication No. 113971015 discloses a method for implementing a MUL64 function with a combinational circuit.

### SUMMARY OF THE INVENTION

Unfortunately, the combinational circuit described in Chinese Unexamined Patent Application Publication No. 113971015 has a 64-stage nesting structure and thus has a complicated configuration, because the maximum value of the second argument of a MUL64×POW function is 63.

One aspect of the present disclosure aims to implement a MUL64 function of a SNOW-3G cipher circuit with a simplified combinational circuit.

To solve the above problem, an integrated circuit according to one aspect of the present disclosure is an integrated circuit that implements a MUL64 function of a SNOW-3G cipher circuit. The integrated circuit includes the following: a calculation circuit configured to calculate, for combinations of integers x and y satisfying n=x+y, 128 1-bit operation results N(n) that are all exclusive ORs of the logical AND of V[x] that is the value of 64-bit V of the x-th bit, and P[y] that is the value of 64-bit P of the y-th bit, where n is an integer ranging from 0 to 127, the value of 64-bit V being the first argument of the MUL64 function, the value of 64-bit P being the second argument of the MUL64 function; and an output circuit configured to output a MUL64 function value [63:0] by performing either a logical-AND operation or an exclusive-OR operation, or both using data indicating 128 pieces of M(n), and using 128 pieces of the N(n). The M(n) is a value calculated by applying 1 to the first argument of a MUL64×POW function included in the MUL64 function, applying the n to the second argument of the MUL64×POW function, and applying a predetermined value to the third argument of the MUL64×POW function.

Further, to solve the above problem, an operation method according to one aspect of the present disclosure is an operation method that implements a MUL64 function of a SNOW-3G cipher circuit. The operation method includes the following steps: calculating, for combinations of integers x and y satisfying n=x+y, 128 1-bit operation results N(n) that are all exclusive ORs of the logical AND of V[x] that is the value of 64-bit V of the x-th bit, and P[y] that is the value of 64-bit P of the y-th bit, where n is an integer ranging from 0 to 127, the value of 64-bit V being the first argument of the MUL64 function, the value of 64-bit P being the second argument of the MUL64 function; and outputting a MUL64 function value [63:0] by performing either a logical-AND operation or an exclusive-OR operation, or both using data indicating 128 pieces of M(n), and using 128 pieces of the N(n). The M(n) is a value calculated by applying 1 to the first argument of a MUL64×POW function included in the MUL64 function, applying the n to the second argument of the MUL64×POW function, and applying a predetermined value to the third argument of the MUL64×POW function.

The aspects of the present disclosure can implement a MUL64 function of a SNOW-3G cipher circuit with a combinational circuit.

### BRIEF DESCRIPTION OF THE DRAWINGS

FIG. 1 is a block diagram illustrating the configuration of an integrated circuit according to a first embodiment of the present disclosure;

FIG. 2 is a table showing some of the values of M(n) according to the first embodiment of the present disclosure;

FIG. 3 is a table showing the values of M(n, i) according to the first embodiment of the present disclosure;

FIG. 4 illustrates part of a Verilog description for calculating a MUL64 function value in the first embodiment of the present disclosure;

FIG. 5 is a flowchart showing an example method that is carried out by the integrated circuit according to the first embodiment of the present disclosure;

FIG. 6 is a block diagram illustrating the configuration of an integrated circuit according to a second embodiment of the present disclosure;

FIG. 7 is a table showing the values of Gm according to the second embodiment of the present disclosure;

FIG. 8 is a flowchart showing an example method that is carried out by the integrated circuit according to the second embodiment of the present disclosure;

FIG. 9 illustrates an example circuit included in the integrated circuit according to the second embodiment of the present disclosure; and

FIG. 10 illustrates part of a Verilog description for calculating a MUL64 function value in the second embodiment of the present disclosure.

### DETAILED DESCRIPTION OF THE INVENTION

### First Embodiment

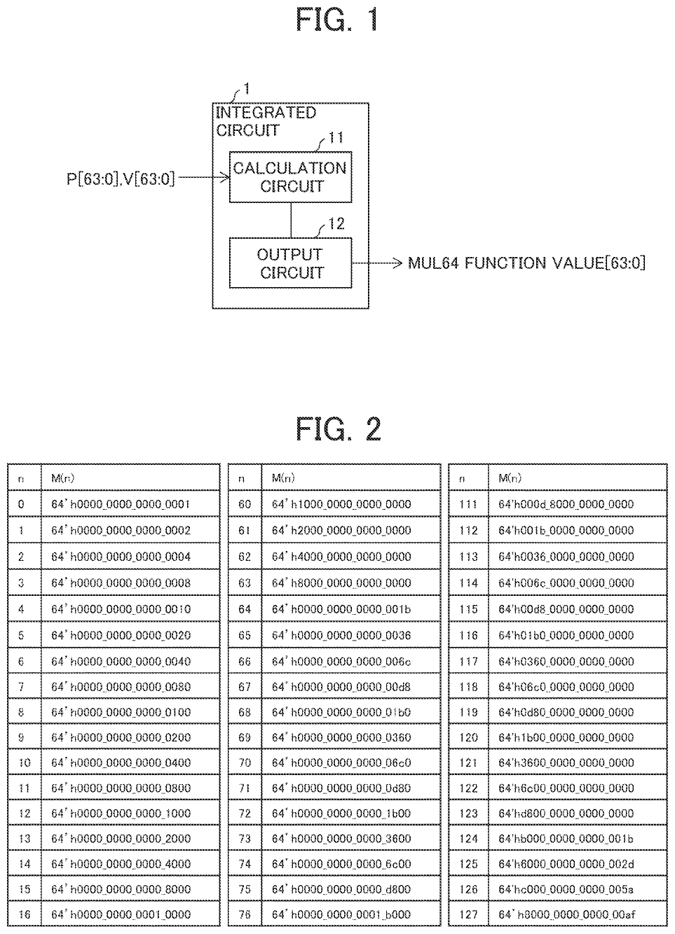

One embodiment of the present disclosure will be detailed with reference to FIGS. 1 to 5.

Method of Calculating MUL64 Function Value

Firstly, the following describes a method of calculating a MUL64 function value, which is the value of a MUL64 function of a SNOW-3G cipher circuit defined in the third generation partnership project (3GPP, registered trademark). A MUL64 function value is defined as follows in 3GPP:

[Numeral 1]

| • result = 0. | |
|---|---|
| • for i = 0 to 63 inclusive | |
| ○ | if (P >>₆₄ i) &₆₄ 0x01 equals 0x01, then |
| | result = result ⊕ MULxPOW(V, i, c). |

Here, V is the 64-bit data of a character string that is a target for encryption. P is 64-bit data indicating an encryption key. Moreover, c is a 64-bit fixed value; although c is fixed at c=0x1b in 3GPP, it may be any value in this embodiment.

Further, MUL×POW(V, i, c) is defined as follows:

[Numeral 2]

```
If i equals 0, then
  MULxPOW(V, i, c) = V,
else
  MULxPOW(V, i, c) = MULx(MULxPOW(V, i − 1, c), c).
```

Further, MUL×(V, c) is defined as follows:

[Numeral 3]

```
If the leftmost (i.e. the most significant) bit of V equals 1, then
  MULx(V, c) = (V <<₆₄ 1) ⊕ c,
else
  MULx(V, c) = V <<₆₄ 1.
```

In this embodiment, the MUL64 function is calculated differently from a function defined in 3GPP, by changing and defining expressions as described below.

Firstly, Expression (1) below is established in MUL64×POW.

MUL64×POW(X xor Y,i,c)=MUL64×POW(X,i,c) xor MUL64×POW(Y,i,c) (1)

That Expression (1) is established can be proved by induction.

M(n) is defined as indicated in Expression (2) below by using Expression (1) above.

M(n)=MUL64×POW(2\hat{ }n,0,0x1b) (2)

As indicated in Expression (2), M(n) is a value that is not dependent on V and P and can be thus calculated in advance. FIG. 2 illustrates some of the values of M(n). FIG. 2 is a table showing some of the values of M(n) according to this embodiment. Moreover, MUL64×POW can be expressed as below by using M(n) calculated through Expression (2).

$$\\ \begin{matrix}[ Numeral 4 ] & \\ MUL 64 xPOW ( V , 0 , 0 x 1 b ) = {\sum }_{n = 0}^{63} \{ V [ n ] \times M ( n ) \} & ( 3 )\end{matrix}$$

Here, the Specification provides Numeral 5 below.

$$\\ \begin{matrix}[ Numeral 5 ] & \\ {\sum }_{n = 0}^{63} \{ \} & \end{matrix}$$

Numeral 5 is defined as being a function that exclusive-ORs individual values calculated by computing braces{ } in n=0 to 63. Further, V[n] denotes the value (zero or one) of V of the n-th bit. Further, a symbol for obtaining the logical AND of a 1-bit variable and a 1-bit variable is specified as “&”, and a symbol for obtaining the product of values of different bits is specified as “×”.

For n (n=0 to 63) with V, which is an argument, of the n-th bit, standing at zero, the right-hand side of Expression (3) is not computed. In contrast, for n with V, which is an argument, of the n-th bit standing at one, the right-hand side of Expression (3) is a function that exclusive-ORs M(n).

That Expression (3) is established can be proved by changing the expression of

V={V[63],V[62],V[61], . . . V[1],V[0]} to

V=(V[63]×2\hat{ }63) xor (V[62]×2\hat{ }62) xor (V[61]×2\hat{ }61)xor . . . xor(V[1]×2\hat{ }1) xor (V[0]×2\hat{ }0),

and substituting it into the left-hand side of Expression (3), and developing it.

Furthermore, Expression (4) below is established in any value of i (i=0 to 63) in MUL64×POW.

$$\\ \begin{matrix}[ Numeral 6 ] & \\ MUL 64 xPOW ( V , i , 0 x 1 b ) = {\sum }_{n = 0}^{63} \{ V [ n ] \times M ( n + i ) \} & ( 4 )\end{matrix}$$

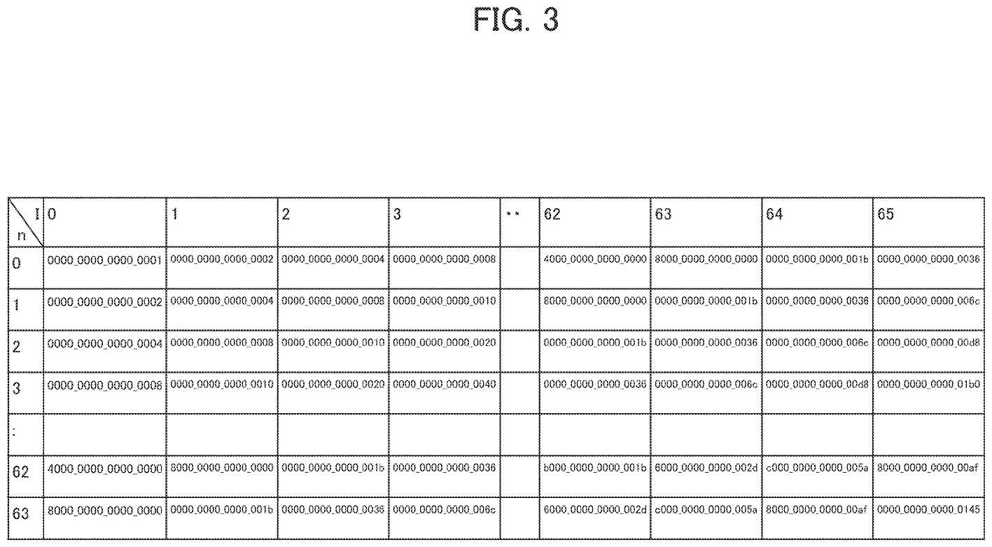

That Expression (4) is established will be described with reference to FIG. 3. FIG. 3 is a table showing the values of M(n, i) according to this embodiment.

Firstly, Expression (5) is defined as below.

M(n,i)=MUL64×POW(2\hat{ }n,i,0x1b) (5)

Then, M(n, i) is calculated in each of n=0 to 63 and i=0 to 63. The calculated results are shown in the table in FIG. 3.

FIG. 3 reveals that M(n, i)=MUL64×POW(2\hat{ }n, i, 0x1b) and M (n, i)=MUL64×POW(2\hat{ }(n−x), (i+x), 0x1b) are equal to each other.

Accordingly, the drawing reveals that there is no problem in defining M(n)=MUL64×POW(2\hat{ }n, 0, 0x1b)=MUL64×POW(2\hat{ }(n−x), (0+n), 0x1b)=MUL64×POW(1, n, 0x1b). That is, M(n) is a value calculated by applying 1 to the first argument of a MUL64×POW function included in the MUL64 function, applying n to the second argument of the same, and applying a predetermined value (0x1b) to the third argument of the same. The predetermined value herein is not limited to a value indicating only (0x1b). The predetermined value herein is a value that may vary as appropriate depending on embodiments.

Next, the MUL64 function is a function that exclusive-ORs MUL64×POW(V, i, c) as frequently as bits whose values of the first argument P[63:0] stand at one. That is, this function is expressed as indicated in Expression (6) below.

$$\\ \begin{matrix}[ Numeral 7 ] & \\ MUL 64 ( V , P , 0 x 1 b ) = {\sum }_{i = 0}^{63} \{ P [ i ] \times MUL 64 xPOW ( V , i , 0 x 1 b ) \} & ( 6 )\end{matrix}$$

Substituting the right-hand side of Expression (4) into MUL64×POW of Expression (6) provides Expression (7) below.

$$\\ \begin{matrix}[ Numeral 8 ] & \\ MUL 64 ( V , P , 0 x 1 b ) = {\sum }_{i = 0}^{63} [ P [ i ] \times {\sum }_{n = 0}^{63} \{ V [ n ] \times M ( n + i ) \} ] & ( 7 )\end{matrix}$$

Developing the right-hand side of Expression (7) provides Expression (8) below.

$$\\ \begin{matrix}[ Numeral 9 ] & \\ MUL 64 ( V , P , 0 x 1 b ) = {\sum }_{i = 0}^{63} [ P [ i ] \times \{ \begin{matrix}( V [ 0 ] \times M ( 0 + i ) x or ( V [ 1 ] \times M ( 1 + i ) x or … \\ x or ( V [ 63 ] \times M ( 63 + i )\end{matrix} \} ] = [ P [ 0 ] \times \{ \begin{matrix}( V [ 0 ] \times M ( 0 ) ) x or ( V [ 1 ] \times M ( 1 ) ) x or … \\ x or ( V [ 63 ] \times M ( 63 ) )\end{matrix} \} ] x or [ P [ 1 ] \times \{ \begin{matrix}( V [ 0 ] \times M ( 1 ) ) x or ( V [ 1 ] \times M ( 2 ) ) x or … \\ x or ( V [ 63 ] \times M ( 64 ) )\end{matrix} \} ] x or [ P [ 2 ] \times \{ \begin{matrix}( V [ 0 ] \times M ( 2 ) ) x or ( V [ 1 ] \times M ( 3 ) ) x or … \\ x or ( V [ 63 ] \times M ( 65 ) )\end{matrix} \} ] … x or [ P [ 63 ] \times \{ \begin{matrix}( V [ 0 ] \times M ( 63 ) ) x or ( V [ 1 ] \times M ( 64 ) ) x or … \\ x or ( V [ 63 ] \times M ( 126 ) )\end{matrix} \} ] & ( 8 )\end{matrix}$$

Organizing Expression (8) using M(n) provides Expression (9) below.

[Numeral 10]

MUL64(V,P,0x1b)=[{P[0]&V[0])×M(0)] xor [{(P[1]&V[0]) xor (P[0]&V[1])}×M(1)] xor [{(P[2]&V[0]) xor (P[1]&V[1]) xor (P[0]&V[2])}×M(2)] . . . xor [{(P[63]&V[63])}×M(126)] (9)

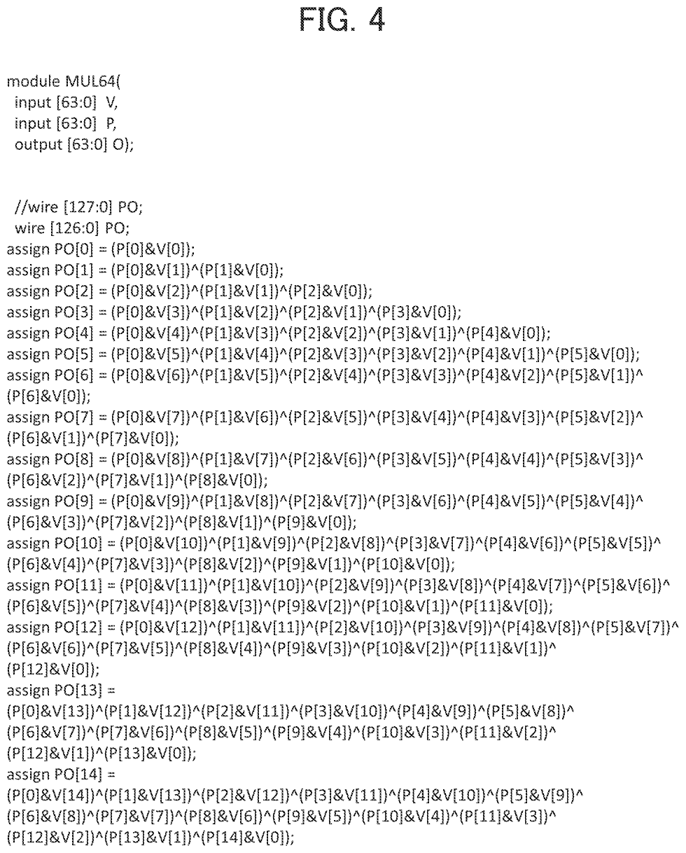

Part of a Verilog description based on Expression (9), for calculating the MUL64 function value is illustrated in FIG. 4. FIG. 4 illustrates part of a Verilog description for calculating the MUL64 function value in this embodiment.

Here, the function N(n) is defined as indicated in Expression (10) below.

$$\\ \begin{matrix}[ Numeral 11 ] & \\ N ( n ) = {\sum }_{x + y = n} ( P [ x ] \& V [ y ] ) & ( 10 )\end{matrix}$$

That is, the exclusive ORed value of the logical AND (P[x]&V[y]) of the value of P of the x-th bit and the value of V of the y-th bit in all (x, y) satisfying x+y=n is defined as N(n).

Substituting Expression (10) into Expression (9) provides Expression (11) below.

$$\\ \begin{matrix}[ Numeral 12 ] & \\ MUL 64 ( V , P , 0 x 1 b ) = [ \{ P [ 0 ] \& V [ 0 ] \} \times M ( 0 ) ] x or [ \{ ( P [ 1 ] \& V [ 0 ] ) x or ( P [ 0 ] \& V [ 1 ] ) \} \times M ( 1 ) ] x or [ \{ ( P [ 2 ] \& V [ 0 ] ) x or ( P [ 1 ] \& V [ 1 ] ) x or ( P [ 0 ] \& V [ 2 ] ) \} \times M ( 2 ) ] … x or [ \{ ( P [ 63 ] \& V [ 63 ] ) \} \times M ( 126 ) ] = \{ N ( 0 ) \times M ( 0 ) \} x or \{ N ( 1 ) \times M ( 1 ) \} x or \{ N ( 2 ) \times M ( 2 ) \} x or … x or \{ N ( 126 \times M ( 126 ) \} = {\sum }_{n = 0}^{126} \{ N ( n ) \times M ( n ) \} & ( 11 )\end{matrix}$$

Expression (11) reveals that the MUL64 function value is calculated by performing logical-AND and exclusive-OR operations of N(n) and M(n), which is a constant.

Integrated Circuit 1

An integrated circuit 1 according to this embodiment is an integrated circuit that implements a MUL64 function of a SNOW-3G cipher circuit defined in the third generation partnership project (3GPP).

FIG. 1 is a block diagram illustrating the configuration of the integrated circuit 1 according to this embodiment. The integrated circuit 1 includes a calculation circuit 11 and an output circuit 12, as illustrated in FIG. 1.

The calculation circuit 11 receives 64-bit V[63:0] that is a character string that is a target for encryption, and that is the first argument of the MUL64 function and receives 64-bit P[63:0]that indicates an encryption key, and that is the second argument of the MUL64 function.

The calculation circuit 11 calculates, for combinations of integers x and y satisfying n=x+y, 128 1-bit operation results N(n) that are all exclusive ORs of the logical AND of V[x] that is the value of V of the x-th bit, and P[y] that is the value of P of the y-th bit, where n is an integer ranging from 0 to 127. The calculation circuit 11 outputs the calculated operation results N(n) to the output circuit 12.

The output circuit 12 outputs a MUL64 function value [63:0] by performing either a logical-AND operation or an exclusive-OR operation, or both using data indicating M(n) calculated in advance, and using N(n) calculated by the calculation circuit 11.

Method that is Carried Out by Integrated Circuit 1

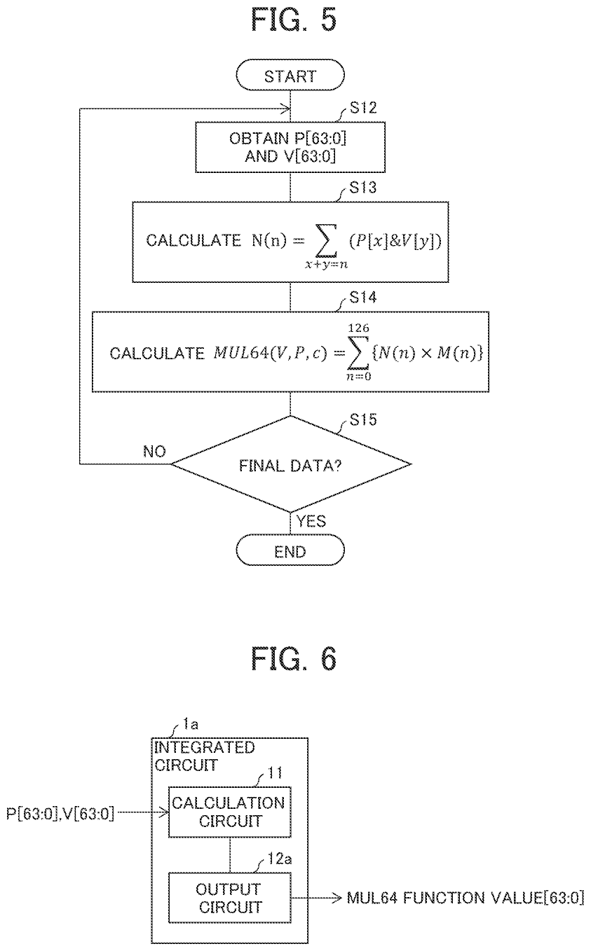

An example method that is carried out by the integrated circuit 1 (in other words, an operation method that implements the MUL64 function of the SNOW-3G cipher circuit) will be described with reference to FIG. 5. FIG. 5 is a flowchart showing an example method that is carried out by the integrated circuit 1 according to this embodiment.

Step S12

In Step S12, the calculation circuit 11 obtains 64-bit V[63:0] that is the first argument of the MUL64 function, and 64-bit P[63:0] that is the second argument of the MUL64 function, and that indicates an encryption key.

Step S13: Calculation Step

In Step S13, the calculation circuit 11 calculates N(n) using Expression (10), which has already been described.

$$\\ \begin{matrix}[ Numeral 13 ] & \\ N ( n ) = {\sum }_{x + y = n} ( P [ x ] \& V [ y ] ) & ( 10 )\end{matrix}$$

That is, in Step S13, the calculation circuit 11 calculates, for combinations of integers x and y satisfying n=x+y, 128 1-bit operation results N(n) that are all exclusive ORs of the logical AND of V[x] that is the value of V[63:0] of the x-th bit obtained in Step S12, and P[y] that is the value of P[63:0] of the y-th bit obtained in Step S12, where n is an integer ranging from 0 to 127.

Step S14: Output Step

In Step S14, the output circuit 12 calculates a MUL64 function value [63:0] using Expression (11), which has already been described, and outputs the MUL64 function value [63:0].

$$\\ \begin{matrix}[ Numeral 14 ] & \\ MUL 64 ( V , P , 0 x 1 b ) = {\sum }_{n = 0}^{126} \{ N ( n ) \times M ( n ) \} & ( 11 )\end{matrix}$$

Here, M(n) is a value calculated using Expression (2), which has already been described.

M(n)=MUL64×POW(2\hat{ }n,0,0x1b) (2)

That is, in Step S14, the output circuit 12 outputs the MUL64 function value [63:0] by performing both of a logical-AND operation and an exclusive-OR operation using data indicating 128 pieces of M(n), and using the 128 pieces of N(n) calculated in Step S13.

To be specific, the output circuit 12 outputs, as MUL64 function values, the exclusive ORs of 128 pieces of M(n)×N(n) calculated through the logical AND of M(n) of each bit and N(n).

Step S15 In Step S15, the calculation circuit 11 determines whether the data that has been input is final data.

If the input data is determined to be final data in Step S15 (If YES in Step S15), the integrated circuit 1 ends the process shown in FIG. 5.

In contrast, if the input data is determined not to be final data in Step S15 (If NO in Step S15), the integrated circuit 1 returns to the processing in Step S12 and executes the processing.

### Effect of First Embodiment

As described above, the integrated circuit 1 according to this embodiment is an integrated circuit that implements a MUL64 function of a SNOW-3G cipher circuit, and that includes the following: the calculation circuit 11 that calculates, for combinations of integers x and y satisfying n=x+y, 128 1-bit operation results N(n) that are all exclusive ORs of the logical AND of V[x] that is the value of 64-bit V of the x-th bit, and P[y] that is the value of 64-bit P of the y-th bit, where n is an integer ranging from 0 to 127, the value of 64-bit V being the first argument of the MUL64 function, the value of 64-bit P being the second argument of the MUL64 function; and the output circuit 12 that outputs a MUL64 function value [63:0] by performing either a logical-AND operation or an exclusive-OR operation, or both using data indicating 128 pieces of M(n), and using 128 pieces of N(n). Further, M(n) is a value calculated by applying 1 to the first argument of a MUL64×POW function included in the MUL64 function, applying n to the second argument of the same, and applying a predetermined value to the third argument of the same.

As described above, the integrated circuit 1 according to this embodiment outputs a MUL64 function value by performing operations on M(n) calculated in advance, and V that is the first argument of the MUL64 function as well as P that is the second argument of the same. The integrated circuit 1 according to this embodiment can consequently implement, with a simplified combinational circuit, a MUL64 function whose arguments have a wide range. In addition, the integrated circuit 1 according to this embodiment, which can implement the MUL64 function with a simplified combinational circuit, reduces variations in processing time and can reduce the risk that a character string that is a target for encryption, or an encryption key is analyzed through power-supply current analysis.

Further, the circuit described in Chinese Unexamined Patent Application Publication No. 113971015 for instance has a shift circuit, and processing conditional branches, and hence, its configuration is complicated. Further, the operation method disclosed in Chinese Unexamined Patent Application Publication No. 113971015 uses the property that for the exclusive OR with 64-bit data, the values of upper 59 bits do not vary. Hence, f0 to f60 are described, whereas f61 to f63 are not described. Hence, in the operation method disclosed in Chinese Unexamined Patent Application Publication No. 113971015, a bit with f0 and 0x1b being exclusive-ORed is highest again, and thus, an exclusive-OR operation dependent on the foregoing property is generated. For this reason, division into cases is complicated in the operation method disclosed in Chinese Unexamined Patent Application Publication No. 113971015.

In contrast, the integrated circuit 1 according to this embodiment can calculate a MUL64 function value through a simpler process than that in the circuit described in Chinese Unexamined Patent Application Publication No. 113971015.

### Second Embodiment

Another embodiment of the present disclosure will be described with reference to FIGS. 6 to 10. It is noted that for convenience in description, components having the same functions as those of the components described in the foregoing embodiment will be denoted by the same signs, and their description will not be repeated.

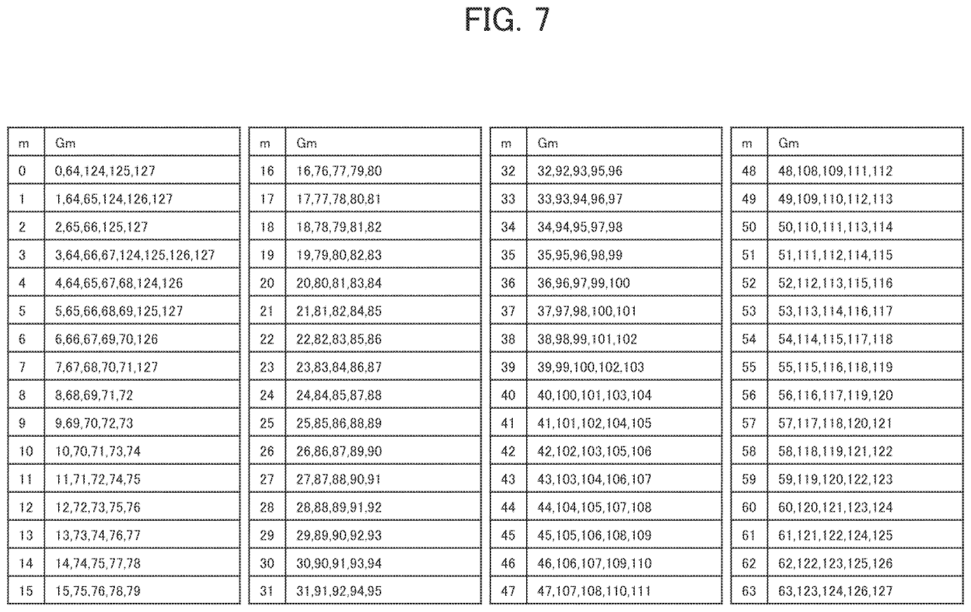

Gm FIG. 2, a table showing some of the values of M(n), reveals that bits with the values of M(n) standing at one are very few. Here, as expressed in Expression (12), MUL64 function values are values with N(n) being exclusive-ORed as frequently as bits whose values of M(n) stand at one. Accordingly, in M(n), where n ranges from 0 to 127, a set of a plurality of pieces of n satisfying that M(n)[m] of the m-th bit is equal to one is defined as Gm. The values of Gm are shown in FIG. 7. FIG. 7 is a table showing the values of Gm in this embodiment.

The MUL64 function value of the m-th bit can be expressed as indicated in Expression (12) below by using Gm.

$$\\ \begin{matrix}[ Numeral 15 ] & \\ MUL 64 ( V , P , 0 x 1 b ) [ m ] = {\sum }_{i = Gm} N ( i ) & ( 12 )\end{matrix}$$

Integrated Circuit 1a

An integrated circuit 1a according to this embodiment is a circuit that uses Gm as data indicating M(n) in the integrated circuit 1 according to the foregoing embodiment.

FIG. 6 is a block diagram illustrating the configuration of the integrated circuit 1a according to this embodiment. The integrated circuit 1a includes the calculation circuit 11 and an output circuit 12a, as illustrated in FIG. 6.

The calculation circuit 11 receives 64-bit V[63:0] that is a character string that is a target for encryption, and that is the first argument of the MUL64 function and receives 64-bit P[63:0] that indicates an encryption key, and that is the second argument of the MUL64 function.

The calculation circuit 11 calculates, for combinations of integers x and y satisfying n=x+y, 128 1-bit operation results N(n) that are all exclusive ORs of the logical AND of V[x] that is the value of V of the x-th bit, and P[y] that is the value of P of the y-th bit, where n is an integer ranging from 0 to 127. The calculation circuit 11 outputs the calculated operation results N(n) to the output circuit 12a.

The output circuit 12a outputs, as the MUL64 function value of the m-th bit, the exclusive OR of N(n) corresponding to a plurality of pieces of n included in Gm that is data indicating M(n) calculated in advance, and that is a set of a plurality of pieces of n satisfying M(n)[m]=1 with regard to M(n) of the m-th bit, where m is an integer ranging from 0 to 63.

Method that is Carried Out by Integrated Circuit 1a

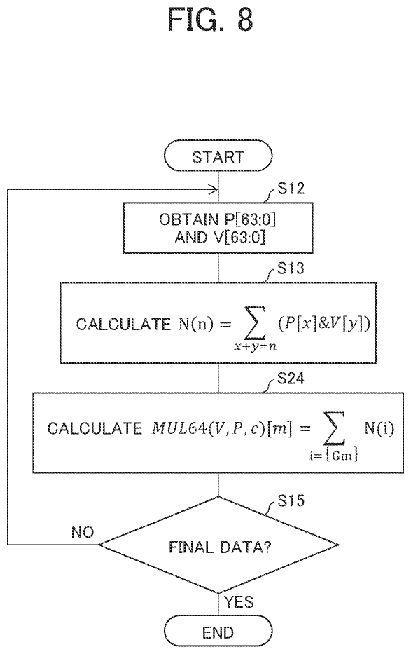

An example method that is carried out by the integrated circuit 1a will be described with reference to FIG. 8. FIG. 8 is a flowchart showing an example method that is carried out by the integrated circuit 1a according to this embodiment.

Step S12 and Step S13: Calculation Step The processing in Step S12 and Step S13, which is the same as the processing in the foregoing embodiment, will not be described.

Step S24: Output Step

In Step S24, the output circuit 12a calculates the MUL64 function value of the m-th bit using foregoing Expression (12) and outputs this MUL64 function value.

That is, in Step S24, the output circuit 12a outputs, as the MUL64 function value of the m-th bit, the exclusive OR of N(n) corresponding to a plurality of pieces of n included in Gm that is data indicating M(n), and that is a set of a plurality of pieces of n satisfying M(n)[m]=1 with regard to M(n) of the m-th bit, where m is an integer ranging from 0 to 63.

Step S15

The processing in Step S15, which is the same as the processing in the foregoing embodiment, will not be described.

Example Circuit

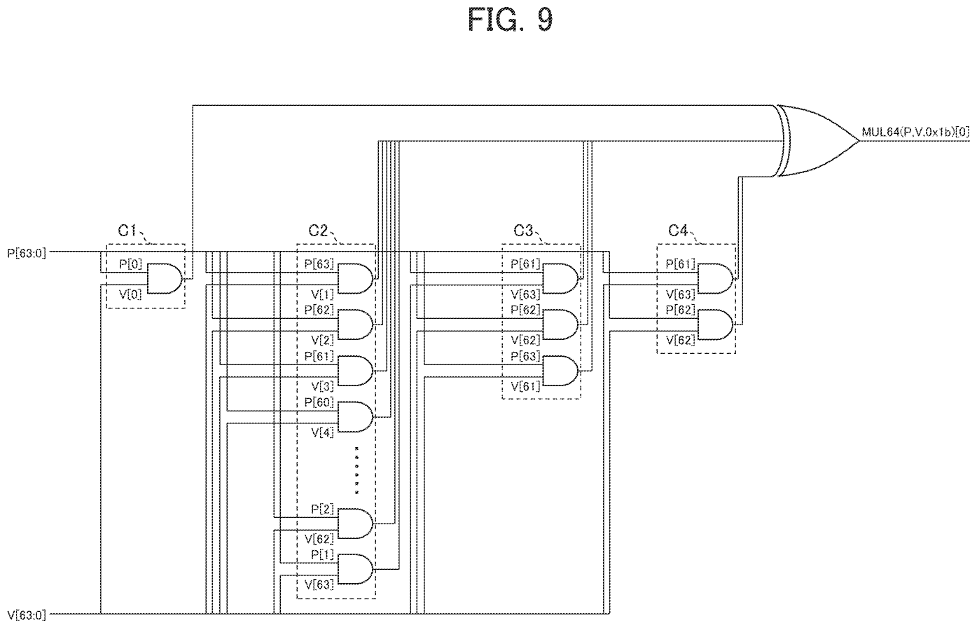

An example circuit included in the integrated circuit 1a is illustrated in FIG. 9. FIG. 9 illustrates an example circuit included in the integrated circuit 1a according to this embodiment.

The circuit in FIG. 9 outputs the value of the least significant bit (m=0) of a MUL64 function value. That is, the circuit in FIG. 9 outputs MUL64[V, P, 0x16][0] with 0 being applied to m in Expression (12). The circuit that outputs MUL64[V, P, 0x16][0] includes a partial circuit C1, a partial circuit C2, a partial circuit C3, and a partial circuit C4, as illustrated in FIG. 9.

In the case of m=0, Gm, which is a set of pieces of n satisfying M(n)[0]=1, is expressed as Gm={0, 64, 124, 125, 127}, as illustrated in FIG. 7. Accordingly, MUL64[V, P, 0x16][0] is expressed as indicated Expression (13) below.

MUL64[V,P,0x1b][0]=N[0] xor N[64] xor N[124] xor N[125] xor N[127] (13)

In FIG. 9, the partial circuit C1 corresponds to N[0] in Expression (13). Further, the partial circuit C2 corresponds to N[64] in Expression (13). Further, the partial circuit C3 corresponds to N[124] in Expression (13). Further, the partial circuit C4 corresponds to N[125] in Expression (13). No circuit corresponding to N[127] is present in FIG. 9 because there is no x and y (x and y each range from 0 to 63) satisfying n=127.

Further, the circuit in FIG. 9 is a circuit corresponding to the case of m=0 in Steps S13 and S24 of the flowchart shown in FIG. 8. Those corresponding to the processing that is executed in Step S13 are the partial circuits C1 to C4 illustrated in FIG. 9. That corresponding to the processing that is executed in Step S24 is an XOR gate in FIG. 9.

As such, the value of the least significant bit of a MUL64 function value is calculated by inputting the outputs of 69 AND gates to a single XOR gate. That is, the circuit that outputs the least significant bit of a MUL64 function value can implement a MUL64 function with a combinational circuit. Likewise, a circuit that outputs m=1 to 63 of a MUL64 function value can be implemented with a combinational circuit.

### Example Description

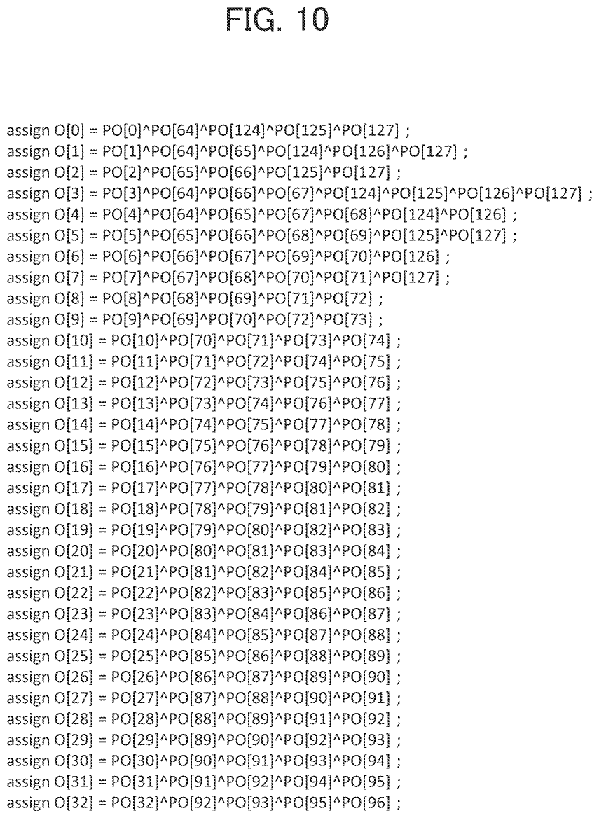

FIG. 10 illustrates part of a Verilog description for calculating a MUL64 function value in this embodiment. As illustrated in FIG. 10, the Verilog description for calculating the MUL64 function value in this embodiment is a description corresponding to Gm and thus has a smaller description volume than the foregoing Verilog description (FIG. 4) in the first embodiment.

### Effect of Second Embodiment

As described, the integrated circuit 1a according to this embodiment outputs, as the MUL64 function value of the m-th bit, the exclusive OR of N(n) corresponding to a plurality of pieces of n included in Gm that is data indicating M(n), and that is a set of a plurality of pieces of n satisfying M(n)[m]=1 with regard to M(n) of the m-th bit, where m is an integer ranging from 0 to 63. The integrated circuit 1a according to this embodiment can consequently implement a MUL64 function with a combinational circuit using a simpler configuration than that in the foregoing integrated circuit 1.

Implementation by Software

The functions of the integrated circuits 1 and 1a can be implemented by a program that causes a computer to function as a device having a function similar to those of the integrated circuits 1 and 1a, ant that causes the computer to function as each block (in particular, blocks having functions similar to those of the calculation circuit 11 and output circuit 12) of the device.

The functions of the integrated circuits 1 and 1a can be also implemented by a program that causes a computer to execute each processing of the operation method that implements a MUL64 function of a SNOW-3G cipher circuit.

The foregoing device in this case includes a computer having, as hardware for executing the foregoing program, at least one controller (e.g., a processor) and at least one storage (e.g., a memory). Executing the program using the controller and storage implements each function described in the foregoing embodiments.

The program may be recorded in one or more non-transitory computer-readable recording medium. This recording medium may or may not be included in the foregoing device. In the latter case, the program may be supplied to the device via any wired or wireless transmission medium.

Further, the function of each block can be also implemented in whole or in part by a logic circuit. For instance, an integrated circuit in which logic circuits that function as respective control blocks are formed is also included in the scope of the present invention. Other than the foregoing, the function of each control block can be also implemented by, for instance, a quantum computer.

### SUMMARY

An integrated circuit (1, 1a) according to a first aspect of the present disclosure is an integrated circuit that implements a MUL64 function of a SNOW-3G cipher circuit. The integrated circuit includes the following: a calculation circuit (11) configured to calculate, for combinations of integers x and y satisfying n=x+y, 128 1-bit operation results N(n) that are all exclusive ORs of the logical AND of V[x] that is the value of 64-bit V of the x-th bit, and P[y] that is the value of 64-bit P of the y-th bit, where n is an integer ranging from 0 to 127, the value of 64-bit V being the first argument of the MUL64 function, the value of 64-bit P being the second argument of the MUL64 function; and an output circuit (12, 12a) configured to output a MUL64 function value [63:0] by performing either a logical-AND operation or an exclusive-OR operation, or both using data indicating 128 pieces of M(n), and using 128 pieces of N(n). M(n) is a value calculated by applying 1 to the first argument of a MUL64×POW function included in the MUL64 function, applying n to the second argument of the MUL64×POW function, and applying a predetermined value to the third argument of the MUL64×POW function.

The foregoing configuration can implement the MUL64 function of the SNOW-3G cipher circuit with a simplified combinational circuit.

The integrated circuit (1, 1a) according to a second aspect of the present disclosure may be configured such that the output circuit (12, 12a) in the first aspect outputs, as the MUL64 function value, the exclusive ORs of 128 pieces of M(n)×N(n) calculated through the logical AND of M(n) of each bit and N(n).

The foregoing configuration can implement the MUL64 function of the SNOW-3G cipher circuit with a simplified combinational circuit.

The integrated circuit (1a) according to a third aspect of the present disclosure may be configured such that the output circuit (12a) in the first aspect outputs, as the MUL64 function value of the m-th bit, the exclusive OR of N(n) corresponding to a plurality of pieces of n included in Gm that is data indicating M(n), and that is a set of a plurality of pieces of n satisfying M(n)[m]=1 with regard to M(n) of the m-th bit, where m is an integer ranging from 0 to 63.

The foregoing configuration can implement the MUL64 function of the SNOW-3G cipher circuit with a simplified combinational circuit.

An operation method according to a fourth aspect of the present disclosure is an operation method that implements a MUL64 function of a SNOW-3G cipher circuit. The operation method includes the following steps: calculating, for combinations of integers x and y satisfying n=x+y, 128 1-bit operation results N(n) that are all exclusive ORs of the logical AND of V[x] that is the value of 64-bit V of the x-th bit, and P[y] that is the value of 64-bit P of the y-th bit, where n is an integer ranging from 0 to 127, the value of 64-bit V being the first argument of the MUL64 function, the value of 64-bit P being the second argument of the MUL64 function; and outputting a MUL64 function value [63:0] by performing either a logical-AND operation or an exclusive-OR operation, or both using data indicating 128 pieces of M(n), and using 128 pieces of N(n). M(n) is a value calculated by applying 1 to the first argument of a MUL64×POW function included in the MUL64 function, applying n to the second argument of the MUL64×POW function, and applying a predetermined value to the third argument of the MUL64×POW function.

The foregoing configuration exerts an effect similar to that of the foregoing integrated circuit.

The present disclosure is not limited to the foregoing embodiments. Various modifications can be devised within the scope of the claims. An embodiment obtained in combination as appropriate with the technical means disclosed in the respective embodiments is also included in the technical scope of the present disclosure. Furthermore, combining the technical means disclosed in the respective embodiments can form a new technical feature.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An integrated circuit that implements a MUL64 function of a SNOW-3G cipher circuit, the integrated circuit comprising:
a calculation circuit configured to calculate, for combinations of integers x and y satisfying n=x+y, 128 1-bit operation results N(n) that are all exclusive ORs of a logical AND of V[x] that is a value of 64-bit V of an x-th bit, and P[y] that is a value of 64-bit P of a y-th bit, where n is an integer ranging from 0 to 127, the value of 64-bit V being a first argument of the MUL64 function, the value of 64-bit P being a second argument of the MUL64 function; and
an output circuit configured to output a MUL64 function value [63:0] by performing either a logical-AND operation or an exclusive-OR operation, or both using data indicating 128 pieces of M(n), and using 128 pieces of the N(n),
wherein the M(n) is a value calculated by applying 1 to a first argument of a MUL64×POW function included in the MUL64 function, applying the n to a second argument of the MUL64×POW function, and applying a predetermined value to a third argument of the MUL64×POW function.

2. The integrated circuit according to claim 1, wherein the output circuit outputs, as the MUL64 function value [63:0], exclusive ORs of 128 pieces of M(n)×N(n) calculated through a logical AND of the M(n) of each bit and the N(n).

3. The integrated circuit according to claim 1, wherein the output circuit outputs, as the MUL64 function value [63:0] of an m-th bit, an exclusive OR of N(n) corresponding to a plurality of pieces of n included in Gm that is data indicating the M(n), and that is a set of a plurality of pieces of n satisfying M(n)[m]=1 with regard to the M(n) of an m-th bit, where m is an integer ranging from 0 to 63.

4. An operation method that implements a MUL64 function of a SNOW-3G cipher circuit, the operation method comprising the steps of:
calculating, for combinations of integers x and y satisfying n=x+y, 128 1-bit operation results N(n) that are all exclusive ORs of a logical AND of V[x] that is a value of 64-bit V of an x-th bit, and P[y] that is a value of 64-bit P of a y-th bit, where n is an integer ranging from 0 to 127, the value of 64-bit V being a first argument of the MUL64 function, the value of 64-bit P being a second argument of the MUL64 function; and
outputting a MUL64 function value [63:0] by performing either a logical-AND operation or an exclusive-OR operation, or both using data indicating 128 pieces of M(n), and using 128 pieces of the N(n),
wherein the M(n) is a value calculated by applying 1 to a first argument of a MUL64×POW function included in the MUL64 function, applying the n to a second argument of the MUL64×POW function, and applying a predetermined value to a third argument of the MUL64×POW function.
